(19) United States
(12) Patent Application Publication
(10) Pub. No.: US 2015/0379972 A1
(43) Pub. Date: Dec. 31, 2015

(54) Mechanical Four-Mallet Revolution

(71) Applicant: Nikil Ragav, Sugar Land, TX (US)

(72) Inventor: Nikil Ragav, Sugar Land, TX (US)

(21) Appl. No.: 14/318,379

(22) Filed: Jun. 27, 2014

(51) Int. Cl. G10D 13/00

(52) U.S. Cl. CPC G10D 13/003

(57) ABSTRACT

This product is a new invention designed to make four-mallet percussion both easier and more ergonomically safe. It incorporates various drawings of the invention and its revisions as well techniques and methods for use by percussionists. The mallet device includes various models of the design—all basically including the shaft for holding, holders to place mallets in, and an apparatus for widening and decreasing intervals between the mallets.

### BACKGROUND OF THE INVENTION

This invention relates to percussion, specifically mallet percussion, and most specifically, four-mallet percussion. The invention aims to create a whole new, revolutionary way to play four-mallet percussion.

Mallet Percussion generally includes marimbas xylophones and vibraphones, aka keyboard instruments. These instruments are made up of bars of various materials including Honduran Rosewood, Paduk wood, synthetic, often fiberglass- and/or polymer-based materials such as Kelon, Zelon, Acoustalon, Jestech, etc. produce pitched sounds when struck with a mallet. These instruments come in various different sizes: this is due to many keyboard instruments having graduated bars where the lower range of bars are both wider and longer than higher-pitched ones. Also, some instruments have more octaves of bars and/or have wider bars than others.

When first learning how to play this type of instruments, percussionists wield only one mallet per hand and songs are not meant to be overly complicated with blocks of chords or otherwise. If more pitches are needed at the same time, multiple percussionists can play at the same time. However this is not ideal when a group has only one percussionist or keyboard instrument as both can be quite expensive.

As a solution, various techniques for wielding a total of four mallets (two in each hand) have been proposed and adopted by members of the percussion society. Popular methods include the Stevens Grip and Burton Grip. Stevens Grip is mostly popular with marimbists whilst Burton is more popular amongst vibraphonists.

In Stevens Grip, one mallet is held with the pinky and ring fingers quite near the end of the mallet. The other mallet's end pivots between the palm near the flesh part near the thumb and the middle finger in what Giff Howarth considers the “Spiderman webbing” motion (Howarth). This mallet's fulcrum is formed by the thumb and ring finger. The hand should be in a “hand shake” position (Howarth). Like with all percussion techniques, muscles should always remain relaxed while playing to prevent lock-ups of muscles, injuries, etc. However, this fact is quite perplexing and paradoxical in Stevens grip because of the obscure muscles required to use the grip. A “piston stroke” is formed by rotating the wrist to strike individual mallets and a “down-up” stroke should be used to play with both mallets in hand in unison (Howarth). Although this grip allows great flexibility in terms of the ability to reach wide intervals (spaces between keys Ex. C to the E above an octave is a 3^{rd} 8va) and the freedom to use the individual mallets, Stevens grip is not very good for playing loudly and conjuring up enough force to do so. This is because the muscles employed in Stevens Grip are not very naturally used and must be constantly worked at with various exercises to maintain proper technique and avoid short-term injuries. However, many years of playing with Stevens Grip has shown that it can lead to arthritis or tendonitis because of the stress on those muscles as it did with professional Ney Rosauro (Rosauro). Damage can be even worse for people who play this grip incorrectly, especially those just starting off with their four-mallet career (Howarth).

Stevens Grip, because of its use of peculiar muscle groups, is also very difficult for new learners to pick up and learn right away. It requires tons of practice and patience and there is still no guarantee that all percussionists will be able to correctly play with this technique.

On the other end of the spectrum, however, Burton Grip is supposed to be much easier to learn and feel much more natural. Burton Grip, being designed for the Vibraphone by vibraphonist Gary Burton, is much sturdier on account for needing much more force to hit metal bars, often loudly. The mallets are held in the hand, “palms down to the floor”, and form a crisscross of sorts (Burton). This grip style still presents its own problems however. For one, intervals cannot be made nearly as wide as Stevens, the individual mallets have much less freedom and control, and roll also cannot be made agreeably, something that Stevens does arguably very well. Also, with Burton Grip comes a clicking noise when the mallets hit the instruments. This occurs because the two mallets hit each other at the point where they cross in the hand. At first, this may seem like a minor annoyance, however clicking noises give the appearance that the percussionist does not maintain his or her equipment well and can deter from the musicians' actual ability when performing.

These reasons are why the aforementioned Ney Rosauro was compelled to create his own grip, the extended-cross grip that attempts to alleviate all the problems by combining elements of both and also attempts to keep the whole thing natural. His grip is a kind of adaptation to Burton because it also follows the pattern of crossing the mallet shafts in the hand. However it also borrows from Stevens and regular two-mallet playing where one mallet is held using the thumb and index finger as fulcrum while the ring finger holds it to the palm. The pinky finger acts as a buffer to prevent clicking. Rosauro's Extended Cross Grip allows a range of play approximately as wide as Stevens, good stability, individual mallet freedom, and it feels arguably the “most natural” (Vega) of all the grips so it is easy for students to pick up and learn right away. However, like all other four-mallet grips, it is still awkward to stick two mallets in each hand. One significant detail that is clearly evident with the relatively recent development of Rosauro's grip is that the four-mallet and multi-mallet industry or style of play is still very much in its infancy and is still awaiting the best solution.

This invention provides an alternative solution for wielding four or more mallets for multi mallet play that is meant to be easy and natural while also providing extended function. The instrument is composed of a single shaft that the percussionist holds, one [1] in each hand, which has an apparatus contained in it to hold two mallets at once. It is also the object of the invention to allow the interval between the two mallets to be changed by the percussionist with the movement of their thumb. The system is designed to be easy to learn and intuitive to play music with.

There are four [4] versions of this system, one utilizing an internal pivot system (nicknamed “mark 1” or the “student edition”), one utilizing a gear system (“mark 2”), and a revised version utilizing a wheel system (“mark 3”). The last two are collectively referred to as “the pro version” because of their extremely wide range all the way from intervals of seconds to more than two octaves, a range of play that cannot nearly be produced simply by mere hands. The shaft and spacers in “mark 2” and “mark 3” are the same; the difference is very minute.

In addition, the invention can be used in conjunction with existing grips such as Stevens or something entirely different to wield six [6] mallets total. This can be accomplished without any injury because the extra mallet can be held in place with minimal movement provided simply to play block chords or can play a note separately.

### DESCRIPTION OF THE DRAWINGS

The thorough workings of the apparatus can be seen more clearly and in greater detail with the detailed descriptions of the accompanying drawings.

FIG. 1 is a thorough top view of the “mark 1” version as if it is laid on a table.

FIG. 2 is a thorough view of “mark 2” in the same style as FIG. 1.

FIG. 3 is a thorough view of the up-down movement apparatus found in “mark 3”. This would simply go in place of the screw and gear design found in “mark 2”.

FIG. 4 is a blow up of the shaft only viewed from the front of the device (where the mallets would be) found in “mark 2” and “mark 3”.

FIG. 5 is a blown up view of the mallet-holding apparatus which consists of an anchor bolt fixture and two sleeve anchors epoxied or otherwise attached onto the ends of the anchor bolt. This is where the mallets are placed in.

FIG. 6 is a thorough view of the up-down movement apparatus found in “mark 4”. This would simply go in place of the rod and wheel with extrusion/borders design found in “mark 3”.

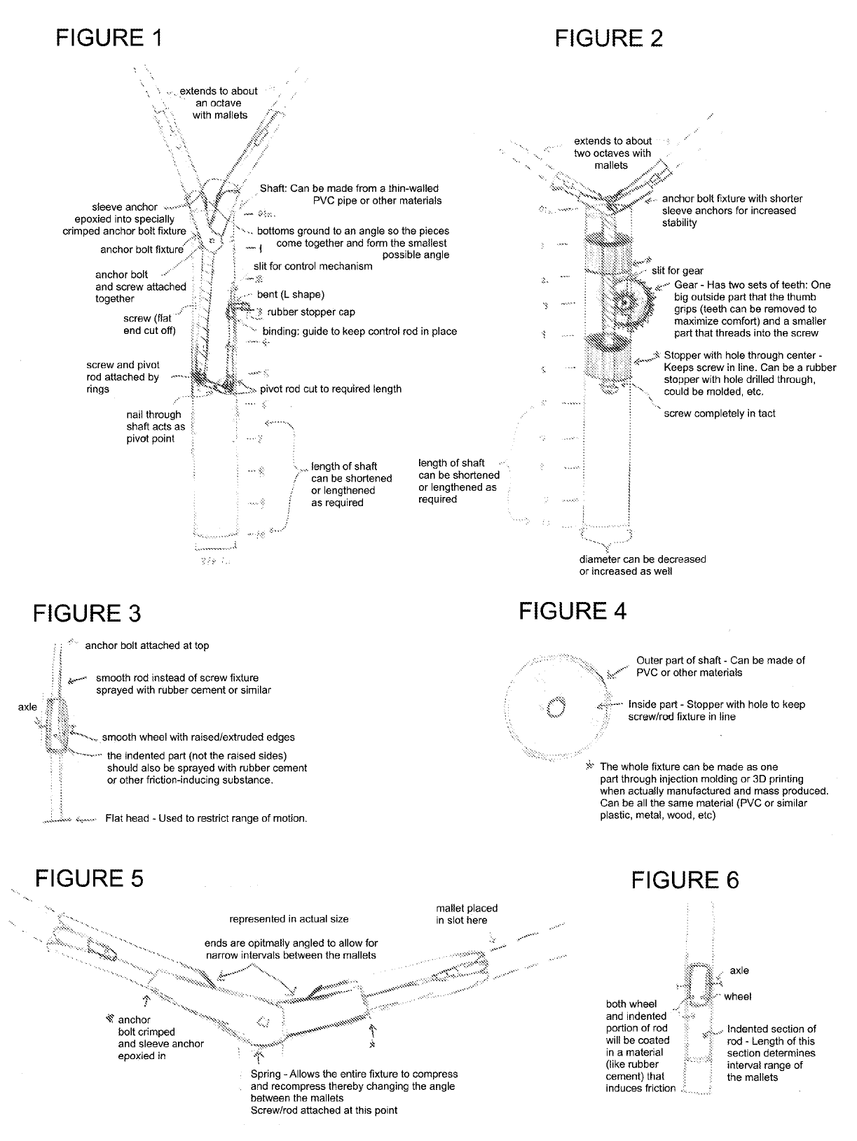

What is claimed is:

1. An improved method for four- and multi-mallet percussion utilizing an original and unique apparatus comprising:
a. A shaft member (original prototypes created out of PVC but can be molded out of another plastic, metals, or even other materials) where one grips the mallets that contain the whole mechanism for widening and narrowing the intervals between the mallets. This can be of varying diameters, thicknesses, and lengths.
b. An anchor bolt and sleeve anchor composition that contains a spring for the widening and narrowing of intervals and forms slots for the placement of mallets. This section can be streamlined into a single, sturdy piece through molding, 3D Printing, or other manufacturing techniques.
c. A lever apparatus for “mark 1” utilizing a rod jutting out of a 1 inch slit from the side of the mallet apparatus that is attached to a central pivoting rod, itself pivoting on a nail passing through the shaft, that pushes the anchor bolt part up and down via an attached screw.
d. A gear for “mark 2” that threads into the aforementioned screw connecting to the anchor bolt to move it up and down.
e. A wheel with an extended edge around it for “mark 3” that rubs against a smooth metal or even plastic rod with a flat end (both sprayed with a rubber cement or similar material used to induce friction) connecting to the anchor bolt to move it up and down.
f. For “mark” 4”: A wheel that has no surface extrusions interacts with a rod similar to that described for “mark 3”. This rod will have an indent that is as wide as the wheel and will be as long as needed for maximum range of motion. Again, a rubber cement type of material will be applied to both the wheel and the indented part of the rod such that friction is generated.
g. A specially ground or cut or molded shaft for “mark 2”, “mark 3”, and “mark 4” that places the screw or rod in the center of the circle of the shaft allowing minimal lateral movement and allowing the respective gear or wheel device to properly make interference with the aforementioned pieces.

2. That any variations of the aforementioned designs will still come under this patent. This could include using different, higher quality materials, making the shaft narrower, flanging out the tip of the shaft, even changing the shape of the grip of the sleeve that mallets would sit in, or even making it electronic and/or battery operated for example.

3. That any mallet can be used with this device, thereby not limiting the percussionists' choice of various sounds and tones as well as not having to cut mallets or buy separate mallets just for use in the device. This means that even new, unique mallets such as the one described in U.S. Pat. No. 4,307,647 can be used with the device as well.

4. “Percussionists always want to and aim to create a piano-like experience on keyboard [mallet] instruments” (Vega). This device will help percussionists achieve that goal as it will allow the possibility of wielding four [4] (one device in each hand), six [6] (one device and one standalone mallet in each hand), or even eight [8] mallets (two devices in each hand as if one was using the devices instead of standalone mallets).
